(19) United States
(12) Patent Application Publication
(10) Pub. No.: US 2024/0187843 A1
(43) Pub. Date: Jun. 6, 2024

(54) Methods for Indicating Reduced Capability UE Information

(71) Applicant: Telefonaktiebolaget LM Ericsson (publ), Stockholm (SE)

(72) Inventors: Mohammed Yazid Lyazidi, London (GB); Liwei Qiu, Täby (SE); Tuomas Tirronen, Helsinki (FI); Qian Chen, Mölndal (SE); Paul Schliwa-Bertling, Ljungsbro (SE); Andreas Höglund, Solna (SE)

(21) Appl. No.: 18/285,354

(22) PCT Filed: Mar. 31, 2022
(86) PCT No.: PCT/EP2022/058719

§ 371 Date: Oct. 2, 2023

Related U.S. Application Data
(60) Provisional application No. 63/170,124, filed on Apr. 2, 2021.

(51) Int. Cl. H04W 8/24

(52) U.S. Cl. CPC H04W 8/24

(57) ABSTRACT

Techniques for handling wireless devices with reduced capabilities, or “RedCap” devices. An example method, performed by a core network node in a wireless communication network having a radio access network and a core network, comprises the step of receiving (32), for a wireless device operating in the radio access network, an indication that the wireless device is a reduced capability device. The method further comprises controlling (34) access to core network services by the wireless device and/or controlling session management for the wireless device, based on the indication.

### TECHNICAL FIELD

The present disclosure is generally related to wireless networks and is more particularly related to handling wireless devices with reduced capabilities in such networks.

### BACKGROUND

The current fifth-generation (5G) radio access network (RAN) architecture is described in the specification document 3GPP TS 38.401, as developed by members of the 3^{rd}-Generation Partnership Project (3GPP). A simplified illustration of the architecture of the 5G RAN or “NG-RAN,” often referred to as “NR,” and its relationship to the 5G core network (5GC) is provided in FIG. 1.

The NG architecture can be further described as follows. The NG-RAN 100 consists of a set of eNBs (LTE terminology for a base station) and gNBs (NR terminology for a base station) connected to the 5GC through the NG interface. An eNB/gNB can support Frequency Division Duplexing (FDD) mode, Time-Division Duplexing (TDD) mode, or dual-mode operation. FIG. 1 illustrates two gNBs 110.

eNB/gNBs 110 can be interconnected to one another through the Xn interface. Some gNBs 110 may have a distributed architecture, in which case the gNB 110 has a single gNB-CU (central unit) 115 and one or several gNB-DUs (distributed units) 120, any or all of which may be physically separated from the gNB-CU 115. A gNB-CU 115 communicates with its DUs 120 through the F1 interface. Note that any given DU 120 is connected to one and only one gNB-CU 115, but a CU 115 may be connected to multiple DUs 120.

NG, Xn and F1 are logical interfaces, specified in detail in the 3GPP standards. For NG-RAN, the NG and Xn-C interfaces for a gNB 110 consisting of a gNB-CU 115 and gNB-DUs 120, terminate in the gNB-CU 115. The gNB-CU 115 and connected gNB-DUs 120 are only visible to other gNBs 110 and the 5GC 130 as a gNB 110.

The NG-RAN 100 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified in 3GPP documentation. The TNL provides services for user plane transport and signaling transport.

FIG. 2 provides a more detailed view of the 5G system architecture (non-roaming), in a reference point representation. The architectural components of the 5G core network shown in FIG. 2 include the Network Slice Selection Function (NSSF) 210, the Authentication Server Function (AUSF) 215, the Network Slice-Specific Authentication and Authorization Function (NSSAAF) 220, the Unified Data Manager (UDM) 225, the 5G Access and Mobility Management Function (AMF) 230, the Session Management Function (SMF) 235, the Policy Control Function (PCF) 240, the Application Function (AF) 245, and the User Plane Function (UPF) 250. The other network components shown in FIG. 2 include the (Radio) Access Network (RAN) 255, the User Equipment (UE) 260, and the data network (DN) 265. Details of each of the illustrated nodes and reference points can be found in 3GPP TS 23.501.

3GPP members have participated in a study of how to support so-called reduced capability wireless devices, referred to as “RedCap” devices, in accordance with a defined Study Item called “Study on support of reduced capability NR devices (FS_NR_redcap).” This study item includes an objective, in 3GPP document 3GPP TR 38.875, on how to ensure RedCap UEs are only used for intended use cases, that is, how to ensure that a UE identifying as a RedCap UE can only use services and resources intended for a RedCap UE type.

### SUMMARY

To support the objective of constraining/differentiating RedCap UE service access, as mentioned in the options listed in the 3gpp TR 38.875 extract above, some network enhancements need to be introduced. In fact, the means of how a NG-RAN node can link the UE being a RedCap UE for the supported bands to an indication to the Access and Mobility Management Function (AMF) signalled over NG-AP is not detailed. Also, the potential purposes and benefits for which this indication could be used by the network (both RAN and CN) are not clear.

Various techniques for addressing these problems are described herein. Introduced are several methods for enabling core network (CN) awareness of RedCap UE type. Being aware of the UE RedCap type, the CN can enable possible constraining/differentiating of RedCap devices, in the event that such constraining or differentiating is required by the operator.

One example method, in a core network node in a wireless communication network having a radio access network and a core network, comprises the step of receiving, for a wireless device operating in the radio access network, an indication that the wireless device is a reduced capability device. This example method further comprises controlling access to core network services by the wireless device and/or controlling session management for the wireless device, based on the indication.

Another example method, also implemented in a core network node in a wireless communication network having a radio access network and a core network, where the core network node comprises an Access and Mobility Management Function (AMF), also comprises the step of receiving, for a wireless device operating in the radio access network, an indication that the wireless device is a reduced capability device. This example method further comprises the step of including the indication that the wireless device is a reduced capability device in either a handover request to a target node for handover of the wireless device or a path switch request to a target node for handover of the wireless device.

Benefits of various embodiments of the techniques detailed below include that they provide flexibility to the network to allow for RedCap capability awareness via multiple signalling options, depending on the requirements. The techniques also provide option to CN for RedCap UE service customization. Other techniques, including methods and procedures carried out by wireless devices and radio access network nodes are described in detail below, as are corresponding apparatuses and systems.

### BRIEF DESCRIPTION OF THE FIGURES

FIG. 1 illustrates the architecture of the 5G NR radio access network (RAN) and associated 5G Core Network (5GCN, or 5GC).

FIG. 2 illustrates the non-roaming 5G system architecture.

FIG. 3 is a process flow diagram illustrating an example method according to some embodiments.

FIG. 4 is a block diagram illustrating an example network node.

FIG. 5 is a block diagram illustrating an example UE, according to some embodiments.

FIG. 6 illustrates an example telecommunication network connected to a host via an intermediate network, in accordance with some embodiments.

FIG. 7 illustrates a host computer communicating over a partially wireless connection with, in accordance with some embodiments.

FIG. 8 is a flowchart illustrating methods implemented in a communication system that includes a host computer, a base station, and a user equipment, in accordance with some embodiments.

FIG. 9 is another flowchart illustrating methods implemented in a communication system that includes a host computer, a base station, and a user equipment, in accordance with some embodiments.

FIG. 10 shows another flowchart illustrating methods implemented in a communication system that includes a host computer, a base station, and a user equipment, in accordance with some embodiments.

FIG. 11 shows still another flowchart illustrating methods implemented in a communication system that includes a host computer, a base station, and a user equipment, in accordance with some embodiments.

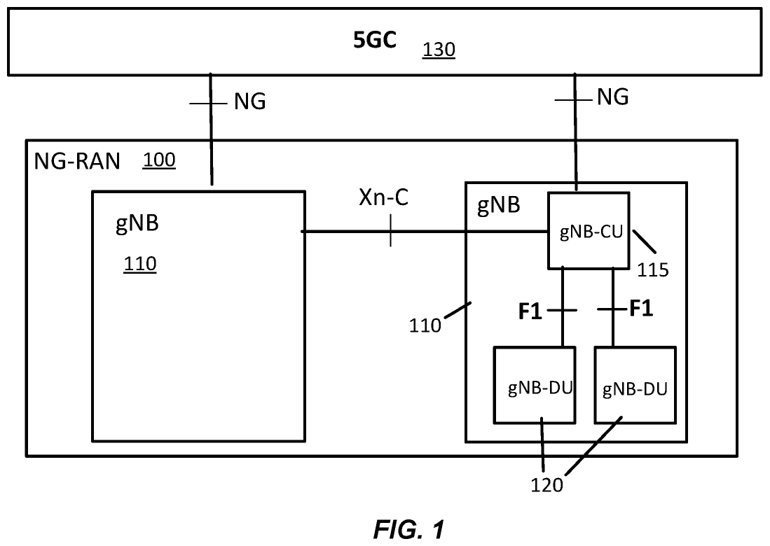

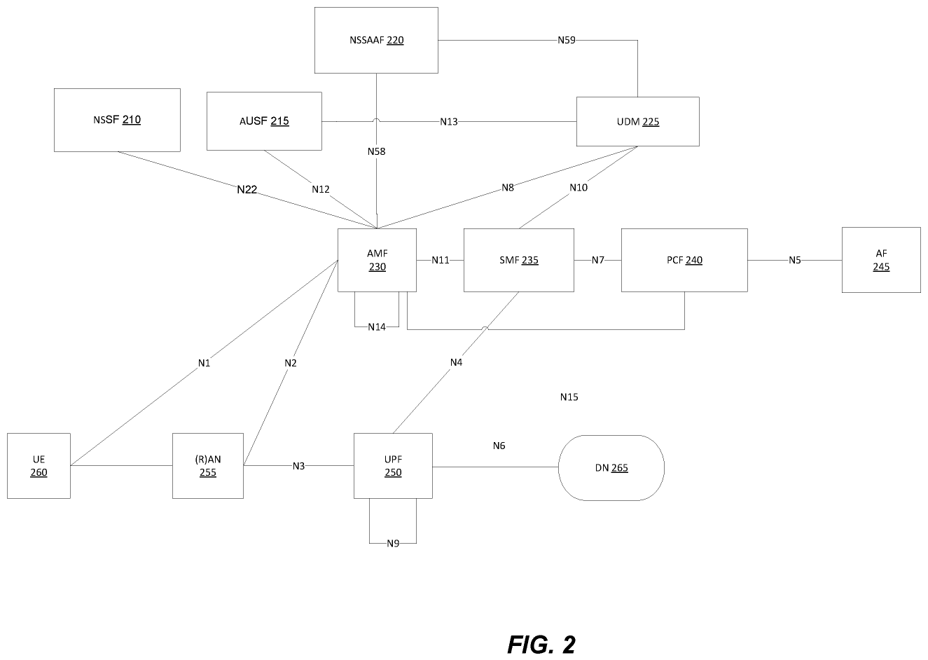

### DETAILED DESCRIPTION

Exemplary embodiments of the present disclosure will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment can be tacitly assumed to be present/used in another embodiment. Any two or more embodiments described in this document may be combined with each other.

Various aspects of the techniques and apparatuses may be described with respect to specific messages or specifications of the NR radio access network (RAN) and the 5G core network (5GCN or 5GC). This is done for purposes of explanation, and it should be understood that the described principles and techniques may be advantageously applied to other wireless networks. References to specific named functions and nodes in the NR RAN and 5GC, such as gNB, AMF, SMF, PCF, etc., should be understood to refer to those nodes and functions as specified by 3GPP specifications and as further modified as necessary to carry out the techniques described herein, as well as to their equivalents in other networks and improvements or successors to the 5G wireless networks specified by 3GPP.

In this document, the terms “UE” and “wireless device” are used interchangeably. While “user equipment” or “UE” refers specifically to a device as specified by 3GPP standards, the terms UE and wireless device as used herein should be understood to encompass any wireless access device or end user device, i.e., a device that access a radio network for services. Furthermore, in this document the term “node” or “network node” is used to refer to an apparatus configured to carry out certain functionality discussed herein. The present discussion refers to several “functions” as defined by 3GPP specifications—any one of those functions may be instantiated in a node, alone or with other functions (including other instantiations of the same function), and in some cases a given function may be distributed among several physically distinct hardware units. Thus, the term “node,” while referring to physical structure, may refer to a single discrete hardware unit or a collection of connected hardware units operating together to provide a certain functionality.

As briefly discussed above, 3GPP is developing specifications for support of so-called reduced capability, or “RedCap” devices in 5G networks. By reduced capability device, or RedCAP UE, is meant that the wireless device has reduced capabilities, compared to devices designed for mobile broadband use, with respect to two or more of: supported bandwidth, maximum number of MIMO layers supported, and maximum downlink modulation order supported. It will be appreciated that all of these reduce baseband and other hardware complexity, enabling smaller and less expensive devices.

As noted above, 3GPP members have participated in a study of how to support so-called reduced capability wireless devices, referred to as “RedCap” devices, in accordance with a defined Study Item called “Study on support of reduced capability NR devices (FS_NR_redcap).” This study item includes an objective, in 3GPP document 3GPP TR 38.875, on how to ensure RedCap UEs are only used for intended use cases, that is, how to ensure that a UE identifying as a RedCap UE can only use services and resources intended for a RedCap UE type.

The following potential solutions can be considered (the solutions do not need to be mutually exclusive), as outlined in 3GPP TR 38.875:
Option 1: RRC Reject based approach
   When the network knows the UE is a RedCap UE and the type of the service requested, RAN can reject an RRC connection establishment attempt if the service the UE requests is not allowed for RedCap UEs. The service type can be known, e.g., based on the establishment cause provided in Msg3, through higher layer mechanisms or other ways.
Option 2: Subscription validation
During the RRC connection setup, the UE indicates that it is a RedCap UE to the core network, e.g.:
   UE includes this indication in NAS signalling message to core network; or
   UE informs this indication during its RRC connection establishment procedure to RAN; RAN then informs core network of the UE's RedCap type in the Initial UE Context message to core network.
   The network validates UE's indication against its subscription plan, which includes information such as the set of services allowed for the UE. Network then decides whether to accept or reject UE's registration request. For example, network may reject UE if UE indicates RedCap, but its subscription does not include any RedCap-specific services.
Option 3: Verification of RedCap UE
   Network performs capability match between UE's reported radio capabilities and the set of capability criteria associated with UE's RedCap type.
Option 4: Left up to network implementation to ensure RedCap UE uses intended services and/or resources.

Discussed below are several different signaling support options for enabling CN awareness of RedCap UE capability. Techniques for service control and differentiation in CN for RedCap UEs are also described.

Signalling support from the radio access network (RAN) may be grouped into two main options:
signalling option 1:
   RAN maps a selected RAN RedCap UE capability (e.g., a 20 MHz device bandwidth) to a RedCap UE type, and informs the CN that the UE is of RedCap type by sending a new indication for RedCap UE in an existing or new NGAP message sent from NG-RAN node to AMF. This might be done, for example, in the NG-AP INITIAL UE MESSAGE.
signalling option 2:
   The information on RedCap UE capability is deduced by the network (e.g., by the gNB) from other UE capabilities, such as bandwidth, and is stored in container(s) sent to other nodes and/or CN. As per legacy handling, the CN can receive the capability from the UE Radio Paging Information in the UE Radio Capability Info Indication procedure from gNB.

Awareness of the RedCap UE capability enables several functions in the CN. In particular, the CN, e.g., the Access Mobility Function (AMF), may use this indication for constraining RedCap devices with respect to, for example, access restriction control based on subscription data or local policy, paging optimization, slice selection in different NFs of the Core Network and for applying different charging policy, as necessary.

A first approach for providing a RedCap indication to the CN is briefly described below.

This first approach, from the UE or wireless device perspective, comprises the following steps:
Step 100. when UE has selected 5GC, the UE includes a RedCap indication in any RRC message, such as the RRC Connection Setup Complete message.
Step 101. Alternatively, RAN deduces the RedCap type from the ‘early identification of UE RedCap type’ in Msg1 or Msg3 (see Alternative 2 below).

This first approach from radio access network (RAN) node (e.g., gNB) perspective:
Step 200. Receives the RedCap indication from the UE via RRC message.
Step 210. Sends a new indication for RedCap UE in the NGAP INITIAL UE MESSAGE message that is sent from NG-RAN node to AMF, or
Step 210. Sending the new indication for RedCap UE to AMF in other new or existing NG-AP message such as the UE CAPABILITY INFO INDICATION message.

This first approach from the CN network node (e.g., AMF) perspective:
Step 300. Receives the NGAP INITIAL UE Message with the RedCap Indication.
Step 310. Stores to information in AMF for future potential actions, e.g., applying access restriction control based on subscription data from UDM or local policy, slice selection, paging optimization, etc.
Step 320. The AMF may send the information to other NF in the Core network, e.g., SMF, PCF, CHF for further slice selection, control and policy differentiations and charging differentiation.

The AMF may also expose the inform to NEF and NWDAF for other smart usage.
Step 330. During N2/N3-based Handover, the AMF may include the RedCap UE indicator in the NG Handover Request procedure towards a new target node.
Step 340. During Xn handover, the AMF may include the RedCap UE indicator in the NG Path Switch Request procedure towards a new target node.

A second approach for providing a RedCap indication to the CN is briefly described below. This may be viewed as involving “implicit” signaling, as the UE Redcap indication is deduced by the RAN node from other signaling.

The second approach, from UE perspective:
Step 101. UE indicates its capabilities using the existing capability framework. Specific capabilities related to RedCap UEs are indicated as specified (e.g., which bandwidth the UE supports, which other features are supported, see RedCap WID)

The second approach from RAN node (e.g., gNB) perspective:
Step 201. Receives the UE Capability Information from RedCap UEs.
Step 211. Based on the received UE capabilities, the gNB (or other network node) deduces that the UE is a RedCap UE. For example, is the UE indicates it only supports 20 MHz bandwidth in FR1, the gNB interprets the UE to be a RedCap UE, or supporting 1 Rx branch in either FR1 or FR2.
   Step 212. The gNB may optionally store information of a particular UE being RedCap in gNB specific memory for future use.
   Step 213 After mapping a selected RAN RedCap UE capability (e.g., 20 MHz device bandwidth) to a RedCap UE type, informing CN that the UE is of RedCap type by sending a new indication for RedCap UE in an existing or new NGAP message sent from NG-RAN node to AMF (e.g., NG-AP INITIAL UE MESSAGE).
Step 221. The RAN is in control of RedCap-specific paging, as needed. The gNB constructs the UE Radio paging Information with list of supported NR bands lists for paging, including the ones for RedCap UEs.
   Step 222. In one alternative, the gNB includes the information of the UE being a RedCap UE in the UE Radio paging information in this step.
   Step 223 In another alternative, the gNB includes the information of the UE being a RedCap UE in other new signaling to AMF and/or to other gNBs/NG-RAN nodes.
Step 231. Sending the UE CAPABILITY INFO INDICATION message to AMF with the UE radio paging information RRC container.
   Step 232. Corresponding to the alternatives in step 221: In one alternative, the UE radio paging information RRC container includes the information of the UE being a RedCap UE.
   Step 233. In another alternative, separate new information element is used to indicate UE being a RedCap UE. This new information element can be part of UE CAPABILITY INFO INDICATION or some other NG-AP signaling
Step 241. Sending the RAN PAGING message from one NG-RAN node to another with the UE radio paging information RRC container.
   Step 242. In an alternative, new signaling is used to indicate the UE is a RedCap UE instead of the radio paging information RRC container.
Step 251. Send the information the UE is a RedCap UE from one NG-RAN node to another to assist with paging.

The second approach from CN node (e.g., AMF) perspective:
Step 301. AMF receiving INITIAL UE MESSAGE from NG-RAN node with indication that the UE is of RedCap type. AMF will store this indication (e.g., with the UE capabilities) which enables separate treatment in CN for RedCap type UEs compared to non-RedCap (MBB) UEs. AMF and other NFs in the Core Network applies differentiations as described in step 310 and 320 above.
   or
Step 301. AMF receiving the UE CAPABILITY INFO INDICATION Message with the RRC paging container, or another NG-AP signaling indicating the UE is a RedCap UE. In case of RedCap UE indication via RRC container, it is assumed that the AMF does not need to discriminate RedCap UEs from other NR UE types.
Step 311. Sending during NG-Paging and UE context related messages the UE radio paging information, or via new NG-AP signaling, or as new information element of RedCap UE type, this indication from CN to RAN.

A third approach for providing a RedCap indication to the CN is briefly described below.

Basic steps of the third approach, from UE perspective:
Step 101. UE indicates it is a RedCap UE during initial access procedure, e.g., in Msg1, Msg3 or MsgA during random access procedure.
Alternatively, the RedCap UE type can be deduced from the use of a separate initial BWP for RedCap.

Basic steps of the third approach from RAN node (e.g., gNB) perspective:
Step 201. Receives indication the UE is a RedCap UE during initial access e.g in Msg1/Msg3 or MsgA.
Rest of the steps are as the same as in the first and second approach, above.

Basic steps of the invention from network node 2 (i.e., AMF) perspective:
as in the first and second approach, above.

A mix of the above options might also be used.

Following is a detailed description of the signaling for the above-summarized approaches.

For the first approach, what follows is a non-limiting example of enhancing the existing 3GPP specifications for Radio Resource Control (RRC) and NG-AP signalling messages to cover the techniques described above, with new changes in bold.

NG-AP signalling (Initial UE message) The following is an example of the signaling described above for the second approach, step 213:

Following is a non-limiting example of enhancing the existing RRC signalling message to cover the second and third approaches summarized above, with new changes in blue highlight for the second approach.

The following is a signaling example of step 340 from the first approach described above.

In some embodiments of the presently disclosed techniques, the RedCap indication, i.e., an indication that the wireless device is a reduced capabilities device, may be included in the UE registration procedure. Below is a modified version of the UE registration procedure from 3GPP TS 23.502, with changes related to the receiving and use of the RedCap indication:

In some embodiments of the presently disclosed techniques, the RedCap indication, i.e., an indication that the wireless device is a reduced capabilities device, may be used in the UE Packet Data Unit (PDU) session establishment procedure. Below is a modified version of the PDU session establishment procedure from 3GPP TS 23.502, with changes related to the receiving and use of the RedCap indication:

In the proposed specification above, the description of step 2 of the illustrated flow references 3GPP TS 23.501 clause 6.3.2. A modified version of that clause, to support the techniques described herein, is provided below:

According to some embodiments of the presently disclosed techniques, the Access and Mobility Management Function (AMF) in the 5GCN uses the RedCap indication in establishing an Access and Mobility (AM) policy, with the Policy and Control Function (PCF). Below is a description of the 3GPP AM policy establishment procedure, as modified to take into account the RedCap indication:

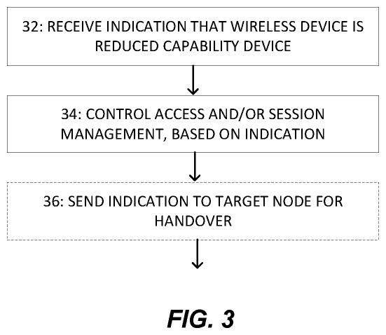

In view of the several techniques and variants described above, any combinations of which may be used together, in some embodiments, it will be appreciated that FIG. 3 is a process flow diagram illustrating a method, in a core network node in a wireless communication network having a radio access network and a core network. The illustrated method may be understood as a generalization of several of the techniques described in detail above—the various details and variations described above are directly applicable to the illustrated method.

As shown at block 32, the illustrated method comprises the step of receiving, for a wireless device operating in the radio access network, an indication that the wireless device is a reduced capability device. As shown at block 34, the method further comprises controlling access to core network services by the wireless device and/or controlling session management for the wireless device, based on the indication.

In some embodiments, the core network node comprises an AMF, and the core network node/AM treats the indication that the wireless device is a reduced capability device as a Radio Access Technology (RAT) type, for purposes of making access control and session management decisions based on RAT type. In some embodiments, the core network node selects a Session Management Function (SMF) based on the indication that the wireless device is a reduced capability device.

In some of these and in some other embodiments, where the core network node comprises an AMF, the method may also comprise including the indication that the wireless device is a reduced capability device in a handover request to a target node for handover of the wireless device. This is shown generally at block 36 of FIG. 3. In an alternative, the core network node/AM may include the indication that the wireless device is a reduced capability device in a path switch request to a target node for handover of the wireless device.

In some embodiments, the core network node comprises at least one of a Policy Control Function (PCF), Session Management Function (SMF), and User Plane Function (UPF), and the core network node treats the indication that the wireless device is a reduced capability device as a Radio Access Technology, RAT, type, for differentiating the wireless device for charging and/or quality-of-service.

In a variation of the method shown in FIG. 3, the core network node also receives, for a wireless device operating in the radio access network, an indication that the wireless device is a reduced capability device, as shown at block 32, and, as shown at block 36, includes the indication that the wireless device is a reduced capability device in either a handover request to a target node for handover of the wireless device or a path switch request to a target node for handover of the wireless device.

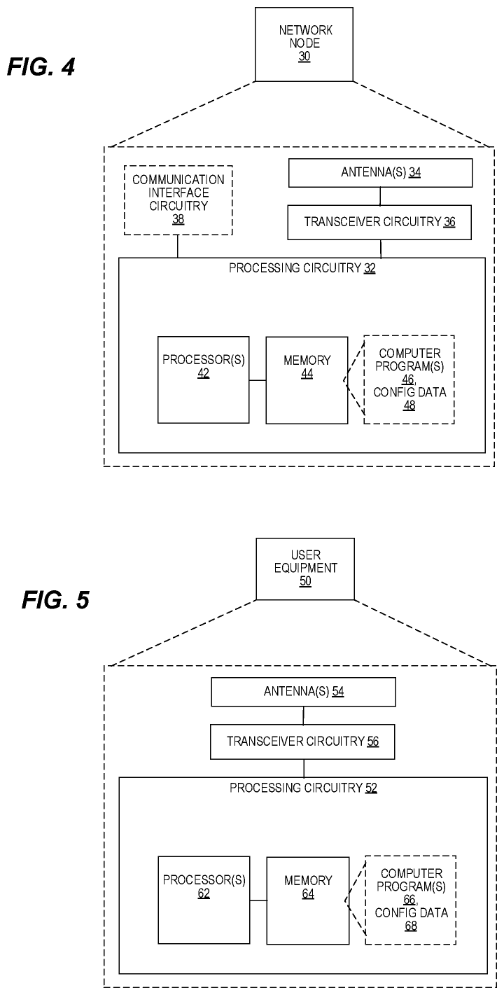

FIG. 4 shows a network node 30, which may be configured to carry out all or parts of one or more of the techniques disclosed herein. In various embodiments, network node 30 may be a radio network node (RAN node) or a core network node. More particularly, network node 30, which in the illustrated example is a radio network node (because it includes a radio for communicating with one or more UEs), such as a gNB or eNB, may perform any of those operations attributed in the above discussion to a network node. In particular, network node 30, when configured as a core network node (in which case antennas 36 and transceiver circuitry 36 are omitted) may carry out a method according to FIG. 3.

When configured as a RAN node, network node 30 may be an evolved Node B (eNodeB), Node B or gNB, for example. While a radio network node 30 is shown in FIG. 4, the operations can be performed by other kinds of network nodes, including a radio network node such as base station, radio base station, base transceiver station, base station controller, network controller, NR base station (BS), Multi-cell/multicast Coordination Entity (MCE), relay node, access point, radio access point, Remote Radio Unit (RRU) Remote Radio Head (RRH), or a multi-standard BS (MSR BS). Network node 30 may also, in some cases, be a core network node (e.g., MME, SON node, a coordinating node, positioning node, MDT node, etc.), or even an external node (e.g., 3rd party node, a node external to the current network), etc. Network node 30 may also comprise test equipment.

When configured as a RAN node, network node 30 facilitates communication between wireless terminals (e.g., UEs), other network access nodes and/or the core network. Whether configured as a RAN node or a CN node, network node 30 may include communication interface circuitry 38 that includes circuitry for communicating with other nodes in the core network, radio nodes, and/or other types of nodes in the network for the purposes of providing data and/or cellular communication services. Some embodiments of network node 30 communicate with wireless devices using antennas 34 and transceiver circuitry 36. Some of these and some other embodiments may communicate with one or more relay nodes using antennas 34 and transceiver circuitry 36, e.g., using antennas 34 and transceiver circuitry 36 to communicate with an MT part of a relay node. Transceiver circuitry 36 may include transmitter circuits, receiver circuits, and associated control circuits that are collectively configured to transmit and receive signals according to a radio access technology, for the purposes of providing cellular communication services.

Network node 30 also includes one or more processing circuits 32 that are operatively associated with the transceiver circuitry 36 and, in some cases, the communication interface circuitry 38. Processing circuitry 32 comprises one or more digital processors 42, e.g., one or more microprocessors, microcontrollers, Digital Signal Processors (DSPs), Field Programmable Gate Arrays (FPGAs), Complex Programmable Logic Devices (CPLDs), Application Specific Integrated Circuits (ASICs), or any mix thereof. More generally, processing circuitry 32 may comprise fixed circuitry, or programmable circuitry that is specially configured via the execution of program instructions implementing the functionality taught herein, or some mix of fixed and programmed circuitry. Processor 42 may be multi-core, i.e., having two or more processor cores utilized for enhanced performance, reduced power consumption, and more efficient simultaneous processing of multiple tasks.

Processing circuitry 32 also includes a memory 44. Memory 44, in some embodiments, stores one or more computer programs 46 and, optionally, configuration data 48. Memory 44 provides non-transitory storage for the computer program 46 and it may comprise one or more types of computer-readable media, such as disk storage, solid-state memory storage, or any mix thereof. Here, “non-transitory” means permanent, semi-permanent, or at least temporarily persistent storage and encompasses both long-term storage in non-volatile memory and storage in working memory, e.g., for program execution. By way of non-limiting example, memory 44 comprises any one or more of SRAM, DRAM, EEPROM, and FLASH memory, which may be in processing circuitry 32 and/or separate from processing circuitry 32. Memory 44 may also store any configuration data 48 used by the network access node 30. Processing circuitry 32 may be configured, e.g., through the use of appropriate program code stored in memory 44, to carry out one or more of the methods and/or signaling processes detailed herein.

Processing circuitry 32 of the network node 30 is configured, according to some embodiments, to perform all or part of the techniques described herein for one or more network nodes of a wireless communication system, including, for example, the methods described in connection with FIG. 3.

FIG. 5 illustrates a diagram of a UE 50 configured to carry out one or more of the techniques, described herein, according to some embodiments. UE 50 may be considered to represent any wireless devices or mobile terminals that may operate in a network, such as a UE in a cellular network. Other examples may include a communication device, target device, device to device (D2D) UE, machine type UE or UE capable of machine-to-machine communication (M2M), a sensor equipped with UE, PDA (personal digital assistant), tablet, IPAD tablet, smart phone, laptop embedded equipped (LEE), laptop mounted equipment (LME), USB dongles, Customer Premises Equipment (CPE), etc.

UE 50 is configured to communicate with a network node or base station in a wide-area cellular network via antennas 54 and transceiver circuitry 56. Transceiver circuitry 56 may include transmitter circuits, receiver circuits, and associated control circuits that are collectively configured to transmit and receive signals according to multiple radio access technologies, for the purposes of using cellular communication services. The radio access technologies can be NR and LTE for the purposes of this discussion.

UE 50 also includes one or more processing circuits 52 that are operatively associated with the radio transceiver circuitry 56. Processing circuitry 52 comprises one or more digital processing circuits, e.g., one or more microprocessors, microcontrollers, DSPs, FPGAs, CPLDs, ASICs, or any mix thereof. More generally, processing circuitry 52 may comprise fixed circuitry, or programmable circuitry that is specially adapted via the execution of program instructions implementing the functionality taught herein or may comprise some mix of fixed and programmed circuitry. Processing circuitry 52 may be multi-core.

Processing circuitry 52 also includes a memory 64. Memory 64, in some embodiments, stores one or more computer programs 66 and, optionally, configuration data 68. Memory 64 provides non-transitory storage for computer program 66 and it may comprise one or more types of computer-readable media, such as disk storage, solid-state memory storage, or any mix thereof. By way of non-limiting example, memory 64 comprises any one or more of SRAM, DRAM, EEPROM, and FLASH memory, which may be in processing circuitry 52 and/or separate from processing circuitry 52. Memory 64 may also store any configuration data 68 used by UE 50. Processing circuitry 52 may be configured, e.g., through the use of appropriate program code stored in memory 64, to carry out one or more of the methods and/or signaling processes discussed above.

Processing circuitry 52 of the UE 50 is configured, according to some embodiments, to perform any methods that support or correspond with the techniques described herein for the network nodes or base station.

While the techniques described above relate to access control and session and policy management of RedCap devices, and thus do not apply directly to the handling of user data, such as application data transferred to and from an applications server in a data network, it will be appreciated that the presently disclosed techniques may be implemented to improve the speed and efficiency of system access by a wireless device, and thus will indirectly improve the operation and efficiency of the wireless device's operation with respect to user-driven applications, whether those applications are voice, video, or data-based applications or services.

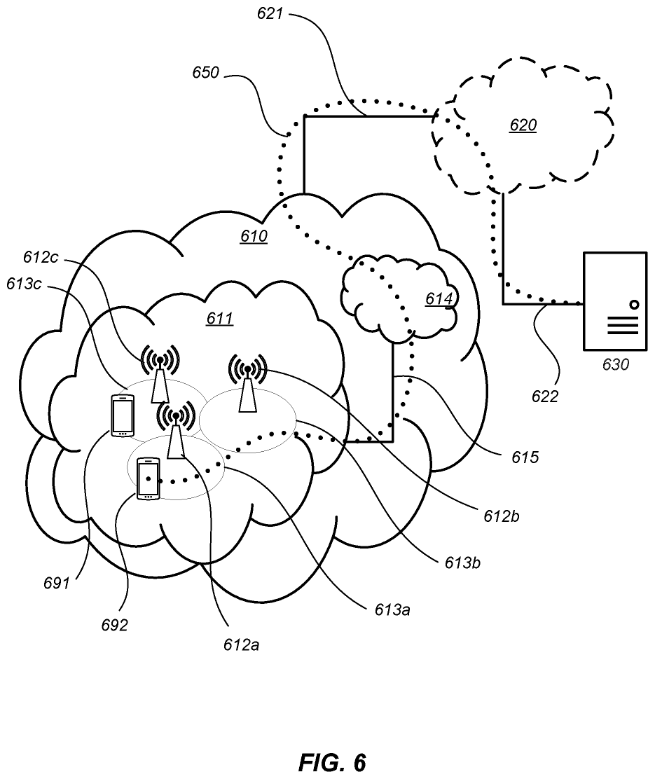

FIG. 6, according to some embodiments, illustrates a communication system that includes a telecommunication network 610, such as a 3GPP-type cellular network, which comprises an access network 611, such as a radio access network, and a core network 614. The access network 611 comprises a plurality of base stations 612a, 612b, 612c, such as NBs, eNBs, gNBs or other types of wireless access points, each defining a corresponding coverage area 613a, 613b, 613c. Each base station 612a, 612b, 612c is connectable to the core network 614 over a wired or wireless connection 615. A first UE 691 located in coverage area 613c is configured to wirelessly connect to, or be paged by, the corresponding base station 612c. A second UE 692 in coverage area 613a is wirelessly connectable to the corresponding base station 612a. While a plurality of UEs 691, 692 are illustrated in this example, the disclosed embodiments are equally applicable to a situation where a sole UE is in the coverage area or where a sole UE is connecting to the corresponding base station 612.

The telecommunication network 610 is itself connected to a host computer 630, which may be embodied in the hardware and/or software of a standalone server, a cloud-implemented server, a distributed server or as processing resources in a server farm. The host computer 630 may be under the ownership or control of a service provider or may be operated by the service provider or on behalf of the service provider. The connections 621, 622 between the telecommunication network 610 and the host computer 630 may extend directly from the core network 614 to the host computer 630 or may go via an optional intermediate network 620. The intermediate network 620 may be one of, or a combination of more than one of, a public, private or hosted network; the intermediate network 620, if any, may be a backbone network or the Internet; in particular, the intermediate network 620 may comprise two or more sub-networks (not shown).

The communication system of FIG. 6 enables connectivity between one of the connected UEs 691, 692 and the host computer 630. The connectivity may be described as an over-the-top (OTT) connection 650. The host computer 630 and the connected UEs 691, 692 are configured to communicate data and/or signaling via the OTT connection 650, using the access network 611, the core network 614, any intermediate network 620 and possible further infrastructure (not shown) as intermediaries. The OTT connection 650 may be transparent in the sense that the participating communication devices through which the OTT connection 650 passes are unaware of routing of uplink and downlink communications. For example, a base station 612 may not or need not be informed about the past routing of an incoming downlink communication with data originating from a host computer 630 to be forwarded (e.g., handed over) to a connected UE 691. Similarly, the base station 612 need not be aware of the future routing of an outgoing uplink communication originating from the UE 691 towards the host computer 630.

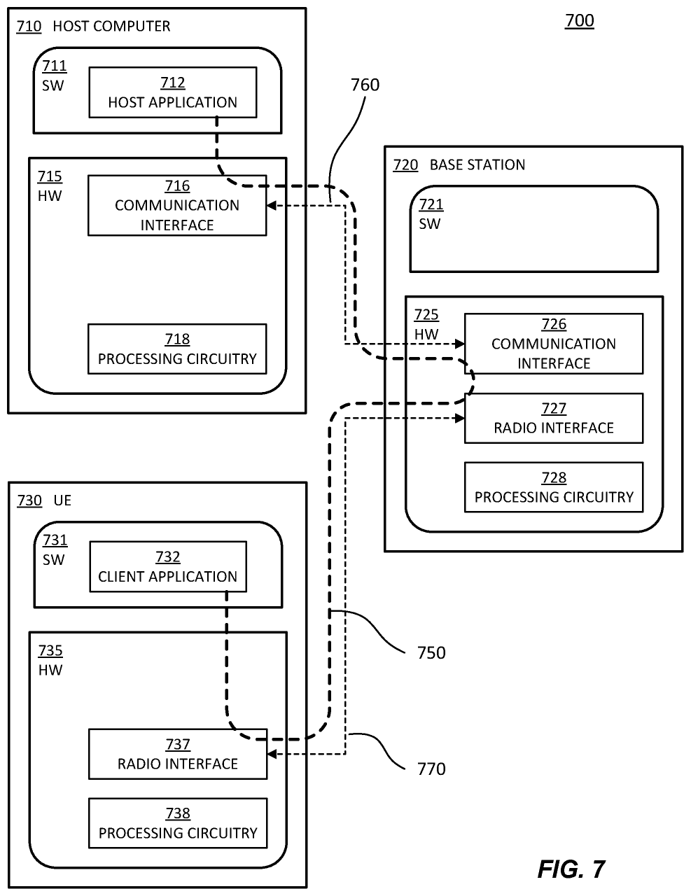

Example implementations, in accordance with an embodiment, of the UE, base station and host computer discussed in the preceding paragraphs will now be described with reference to FIG. 7.

In communication system 700, a host computer 710 comprises hardware 715 including a communication interface 716 configured to set up and maintain a wired or wireless connection with an interface of a different communication device of the communication system 700. The host computer 710 further comprises processing circuitry 718, which may have storage and/or processing capabilities. In particular, the processing circuitry 718 may comprise one or more programmable processors, application-specific integrated circuits, field programmable gate arrays or combinations of these (not shown) adapted to execute instructions. The host computer 710 further comprises software 711, which is stored in or accessible by the host computer 710 and executable by the processing circuitry 718. The software 711 includes a host application 712. The host application 712 may be operable to provide a service to a remote user, such as a UE 730 connecting via an OTT connection 750 terminating at the UE 730 and the host computer 710. In providing the service to the remote user, the host application 712 may provide user data which is transmitted using the OTT connection 750.

The communication system 700 further includes a base station 720 provided in a telecommunication system and comprising hardware 725 enabling it to communicate with the host computer 710 and with the UE 730. The hardware 725 may include a communication interface 726 for setting up and maintaining a wired or wireless connection with an interface of a different communication device of the communication system 700, as well as a radio interface 727 for setting up and maintaining at least a wireless connection 770 with a UE 730 located in a coverage area (not shown in FIG. 7) served by the base station 720. The communication interface 726 may be configured to facilitate a connection 760 to the host computer 710. The connection 760 may be direct or it may pass through a core network (not shown in FIG. 7) of the telecommunication system and/or through one or more intermediate networks outside the telecommunication system. In the embodiment shown, the hardware 725 of the base station 720 further includes processing circuitry 728, which may comprise one or more programmable processors, application-specific integrated circuits, field programmable gate arrays or combinations of these (not shown) adapted to execute instructions. The base station 720 further has software 721 stored internally or accessible via an external connection.

The communication system 700 further includes the UE 730 already referred to. Its hardware 735 may include a radio interface 737 configured to set up and maintain a wireless connection 770 with a base station serving a coverage area in which the UE 730 is currently located. The hardware 735 of the UE 730 further includes processing circuitry 738, which may comprise one or more programmable processors, application-specific integrated circuits, field programmable gate arrays or combinations of these (not shown) adapted to execute instructions. The UE 730 further comprises software 731, which is stored in or accessible by the UE 730 and executable by the processing circuitry 738. The software 731 includes a client application 732. The client application 732 may be operable to provide a service to a human or non-human user via the UE 730, with the support of the host computer 710. In the host computer 710, an executing host application 712 may communicate with the executing client application 732 via the OTT connection 750 terminating at the UE 730 and the host computer 717. In providing the service to the user, the client application 732 may receive request data from the host application 712 and provide user data in response to the request data. The OTT connection 750 may transfer both the request data and the user data. The client application 732 may interact with the user to generate the user data that it provides.

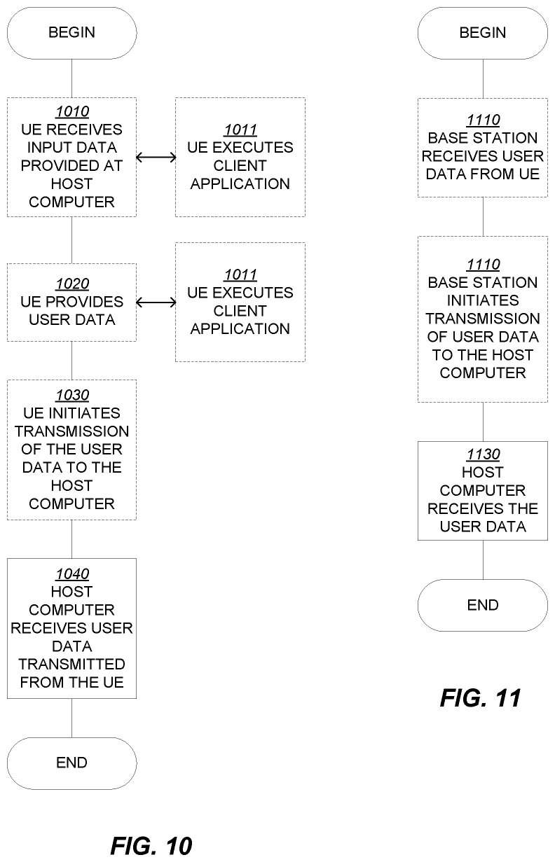

It is noted that the host computer 710, base station 720 and UE 730 illustrated in FIG. 10 may be identical to the host computer 630, one of the base stations 612a, 612b, 612c and one of the UEs 691, 692 of FIG. 6, respectively. This is to say, the inner workings of these entities may be as shown in FIG. 7 and independently, the surrounding network topology may be that of FIG. 6.

In FIG. 7, the OTT connection 750 has been drawn abstractly to illustrate the communication between the host computer 710 and the use equipment 730 via the base station 720, without explicit reference to any intermediary devices and the precise routing of messages via these devices. Network infrastructure may determine the routing, which it may be configured to hide from the UE 730 or from the service provider operating the host computer 710, or both. While the OTT connection 750 is active, the network infrastructure may further take decisions by which it dynamically changes the routing (e.g., on the basis of load balancing consideration or reconfiguration of the network).

The wireless connection 770 between the UE 730 and the base station 720 is in accordance with the teachings of the embodiments described throughout this disclosure, such as provided by nodes such as UE 50 and network node 30, along with the corresponding method illustrated in FIG. 3. The embodiments described herein allow IAB nodes and UEs to more efficiently respond to and react to network problems, such as the failure of a backhaul link, and more particularly provide more efficient release techniques in the event of such a failure. The teachings of these embodiments may improve the reliability, data rate, capacity, latency and/or power consumption for the network and UE 730 using the OTT connection 750 for emergency warning systems and thereby provide benefits such as more efficient and targeted emergency messaging that saves on network and UE resources while improving the ability of users to take safe action.

A measurement procedure may be provided for the purpose of monitoring data rate, latency and other factors on which the one or more embodiments improve. There may further be an optional network functionality for reconfiguring the OTT connection 750 between the host computer 710 and UE 730, in response to variations in the measurement results. The measurement procedure and/or the network functionality for reconfiguring the OTT connection 750 may be implemented in the software 711 of the host computer 710 or in the software 731 of the UE 730, or both. In embodiments, sensors (not shown) may be deployed in or in association with communication devices through which the OTT connection 750 passes; the sensors may participate in the measurement procedure by supplying values of the monitored quantities exemplified above, or supplying values of other physical quantities from which software 711, 731 may compute or estimate the monitored quantities. The reconfiguring of the OTT connection 750 may include message format, retransmission settings, preferred routing etc.; the reconfiguring need not affect the base station 720, and it may be unknown or imperceptible to the base station 720. Such procedures and functionalities may be known and practiced in the art. In certain embodiments, measurements may involve proprietary UE signaling facilitating the host computer's 710 measurements of throughput, propagation times, latency and the like. The measurements may be implemented in that the software 711, 731 causes messages to be transmitted, in particular, empty or ‘dummy’ messages, using the OTT connection 750 while it monitors propagation times, errors etc.

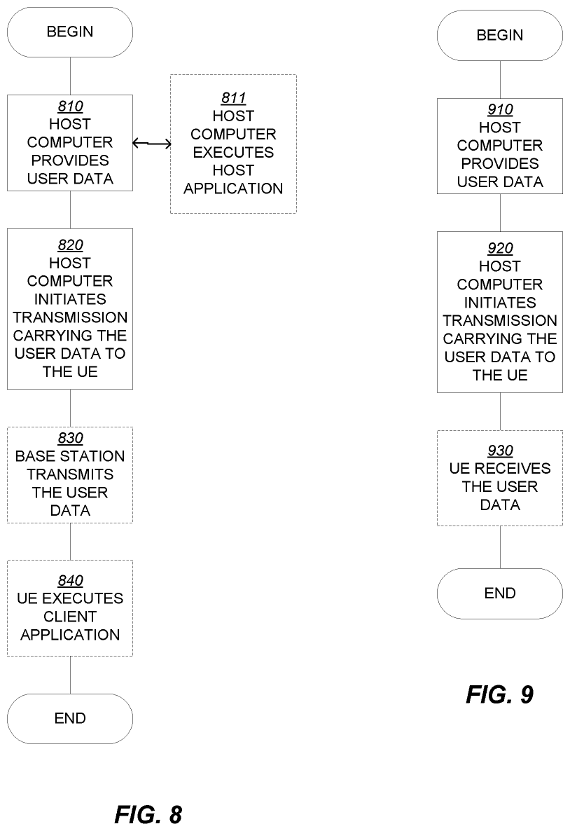

FIG. 8 is a flowchart illustrating a method implemented in a communication system, in accordance with one embodiment.

The communication system includes a host computer, a base station and a UE which may be those described with reference to FIGS. 4 and 5. For simplicity of the present disclosure, only drawing references to FIG. 8 will be included in this section. In a first step 810 of the method, the host computer provides user data. In an optional substep 811 of the first step 810, the host computer provides the user data by executing a host application. In a second step 820, the host computer initiates a transmission carrying the user data to the UE. In an optional third step 830, the base station transmits to the UE the user data which was carried in the transmission that the host computer initiated, in accordance with the teachings of the embodiments described throughout this disclosure. In an optional fourth step 840, the UE executes a client application associated with the host application executed by the host computer.

FIG. 9 is a flowchart illustrating a method implemented in a communication system, in accordance with one embodiment.

The communication system includes a host computer, a base station and a UE which may be those described with reference to FIGS. 4 and 5. For simplicity of the present disclosure, only drawing references to FIG. 9 will be included in this section. In a first step 910 of the method, the host computer provides user data. In an optional substep (not shown), the host computer provides the user data by executing a host application. In a second step 920, the host computer initiates a transmission carrying the user data to the UE. The transmission may pass via the base station, in accordance with the teachings of the embodiments described throughout this disclosure. In an optional third step 930, the UE receives the user data carried in the transmission.

FIG. 10 is a flowchart illustrating a method implemented in a communication system, in accordance with one embodiment.

The communication system includes a host computer, a base station and a UE which may be those described with reference to FIGS. 4 and 5. For simplicity of the present disclosure, only drawing references to FIG. 10 will be included in this section. In an optional first step 1010 of the method, the UE receives input data provided by the host computer. Additionally, or alternatively, in an optional second step 1020, the UE provides user data. In an optional substep 1021 of the second step 1020, the UE provides the user data by executing a client application. In a further optional substep 1011 of the first step 1010, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1030, transmission of the user data to the host computer. In a fourth step 1040 of the method, the host computer receives the user data transmitted from the UE, in accordance with the teachings of the embodiments described throughout this disclosure.

FIG. 11 is a flowchart illustrating a method implemented in a communication system, in accordance with one embodiment.

The communication system includes a host computer, a base station and a UE which may be those described with reference to FIGS. 4 and 5. For simplicity of the present disclosure, only drawing references to FIG. 11 will be included in this section. In an optional first step 1110 of the method, in accordance with the teachings of the embodiments described throughout this disclosure, the base station receives user data from the UE. In an optional second step 1120, the base station initiates transmission of the received user data to the host computer. In a third step 1130, the host computer receives the user data carried in the transmission initiated by the base station.

As discussed in detail above, the techniques described herein, e.g., as illustrated in the process flow diagram of FIG. 3, may be implemented, in whole or in part, using computer program instructions executed by one or more processors. It will be appreciated that a functional implementation of these techniques may be represented in terms of functional modules, where each functional module corresponds to a functional unit of software executing in an appropriate processor or to a functional digital hardware circuit, or some combination of both.

### EXAMPLE EMBODIMENTS

In view of the detailed examples and description above, it will be appreciated that embodiments of the presently disclosed inventive techniques and apparatuses may include, but are not necessarily limited to, the following enumerated examples:

Example 1. A method, in a core network node in a wireless communication network having a radio access network and a core network, the method comprising: receiving, for a wireless device operating in the radio access network, an indication that the wireless device is a reduced capability device; and controlling access to core network services by the wireless device and/or controlling session management for the wireless device, based on the indication.

Example 2. The method of example 1, wherein the core network node selects a Session Management Function, SMF, based on the indication that the wireless device is a reduced capability device.

Example 3. The method of example 1 or 2, wherein the core network node comprises an Access and Mobility Management Function, AMF, and wherein the core network node treats the indication that the wireless device is a reduced capability device as a Radio Access Technology, RAT, type, for purposes of making access control and session management decisions based on RAT type.

Example 4. The method of any of examples 1-3, wherein the core network node comprises an Access Mobility Function, AMF, and wherein the method comprises including the indication that the wireless device is a reduced capability device in a handover request to a target node for handover of the wireless device.

Example 5. The method of any of examples 1-3, wherein the core network node comprises an Access and Mobility Management Function, AMF, and wherein the method comprises including the indication that the wireless device is a reduced capability device in a path switch request to a target node for handover of the wireless device.

Example 6. The method of example 1, wherein the core network node comprises at least one of a Policy Control Function, PCF, Session Management Function, SMF, and User Plane Function (UPF), and wherein the core network node treats the indication that the wireless device is a reduced capability device as a Radio Access Technology, RAT, type, for differentiating the wireless device for charging and/or quality-of-service.

Example 7. A method, in a core network node in a wireless communication network having a radio access network and a core network, wherein the core network node comprises an Access and Mobility Management Function, AMF, the method comprising: receiving, for a wireless device operating in the radio access network, an indication that the wireless device is a reduced capability device; and including the indication that the wireless device is a reduced capability device in either a handover request to a target node for handover of the wireless device or a path switch request to a target node for handover of the wireless device.

Example 8. A core network node adapted to carry out a method according to any one of examples 1-7.

Example 9. A core network node, comprising: communications interface circuitry; and processing circuitry operatively associated with the communications interface circuitry and configured to: receive, for a wireless device operating in the radio access network, an indication that the wireless device is a reduced capability device; and control access to core network services by the wireless device and/or controlling session management for the wireless device, based on the indication.

Example 10. The core network node of example 9, wherein the core network node comprises an Access and Mobility Management Function, AMF, and wherein the processing circuitry is configured to treat the indication that the wireless device is a reduced capability device as a Radio Access Technology, RAT, type, for purposes of making access control and session management decisions based on RAT type.

Example 11. The core network node of any of examples 9-10, wherein the processing circuitry is configured to select a Session Management Function, SMF, based on the indication that the wireless device is a reduced capability device.

Example 12. The core network node of any of examples 9-11, wherein the core network node comprises an Access Mobility Function, AMF, and wherein the processing circuitry is configured to include the indication that the wireless device is a reduced capability device in a handover request to a target node for handover of the wireless device.

Example 13. The core network node of any of examples 9-11, wherein the core network node comprises an Access and Mobility Management Function, AMF, and wherein the processing circuitry is configured to include the indication that the wireless device is a reduced capability device in a path switch request to a target node for handover of the wireless device.

Example 14. The core network node of example 9, wherein the core network node comprises at least one of a Policy Control Function, PCF, Session Management Function, SMF, and User Plane Function (UPF), and wherein the processing circuitry is configured to treat the indication that the wireless device is a reduced capability device as a Radio Access Technology, RAT, type, for differentiating the wireless device for charging and/or quality-of-service.

Example 15. A core network node, comprising: communications interface circuitry; and processing circuitry operatively associated with the communications interface circuitry and configured to: receive, for a wireless device operating in the radio access network, an indication that the wireless device is a reduced capability device; and include the indication that the wireless device is a reduced capability device in either a handover request to a target node for handover of the wireless device or a path switch request to a target node for handover of the wireless device.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents and shall not be restricted or limited by the foregoing detailed description.

1-17. (canceled)

18. A method, performed by a core network node in a wireless communication network having a radio access network and a core network, the method comprising:
receiving, for a wireless device operating in the radio access network, an indication that the wireless device is a reduced capability device; and
controlling access to core network services by the wireless device and/or controlling session management for the wireless device, based on the indication,
wherein the core network node treats the indication that the wireless device is a reduced capability device as a Radio Access Technology (RAT) type, for purposes of making access control and session management decisions based on RAT type.

19. The method of claim 18, wherein the controlling session management comprises one or more of:
further network slice selection;
control and policy differentiations;
charging differentiation.

20. The method of claim 18, wherein the method comprises:
including the indication that the wireless device is a reduced capability device in a handover request to a target node for handover of the wireless device.

21. The method of claim 18, wherein the method comprises:
including the indication that the wireless device is a reduced capability device in a path switch request to a target node for handover of the wireless device.

22. The method of claim 18, wherein the core network node treats the indication that the wireless device is a reduced capability device as a Radio Access Technology (RAT) type, for differentiating the wireless device for charging and/or quality-of-service.

23. A core network node, comprising:
communications interface circuitry; and
processing circuitry operatively associated with the communications interface circuitry and configured to:
receive, for a wireless device operating in the radio access network, an indication that the wireless device is a reduced capability device; and
control access to core network services by the wireless device and/or controlling session management for the wireless device, based on the indication,
wherein the processing circuitry is configured to treat the indication that the wireless device is a reduced capability device as a Radio Access Technology (RAT) type, for purposes of making access control and session management decisions based on RAT type.

24. The core network node of claim 23, wherein the processing circuitry is configured to select a Session Management Function (SMF) based on the indication that the wireless device is a reduced capability device.

25. The core network node of claim 23, wherein the controlling session management comprises one or more of:
further network slice selection;
control and policy differentiations;
charging differentiation.

26. The core network node of claim 23, wherein the processing circuitry is configured to include the indication that the wireless device is a reduced capability device in a handover request to a target node for handover of the wireless device.

27. The core network node of claim 23, wherein the processing circuitry is configured to include the indication that the wireless device is a reduced capability device in a path switch request to a target node for handover of the wireless device.

28. The core network node of claim 23, wherein the core network node comprises at least one of a Policy Control Function (PCF), Session Management Function (SMF), and User Plane Function (UPF), and wherein the processing circuitry is configured to treat the indication that the wireless device is a reduced capability device as a Radio Access Technology (RAT) type, for differentiating the wireless device for charging and/or quality-of-service.

29. A non-transitory computer-readable medium comprising, stored thereupon, a computer program product comprising computer program instructions for execution by a processing circuit in a core network node, the computer program instructions being configured to cause the network node to:
receive, for a wireless device operating in the radio access network, an indication that the wireless device is a reduced capability device; and
control access to core network services by the wireless device and/or controlling session management for the wireless device, based on the indication,
wherein the computer program instructions are configured to cause the core network node to treat the indication that the wireless device is a reduced capability device as a Radio Access Technology (RAT) type, for purposes of making access control and session management decisions based on RAT type.
